(19) United States
(12) Patent Application Publication
(10) Pub. No.: US 2005/0095550 A1
(43) Pub. Date: May 5, 2005

(54) Orthodontic implant

(76) Inventors: Jung-Moon Kim, Seoul (KR); Jong-Woo Kim, Seoul (KR); Young-Chel Park, Seoul (KR); Jong-Suk Lee, Seoul (KR)

Correspondence Address: CANTOR COLBURN LLP, 55 Griffin Road South, Bloomfield, CT, 06002, US

(21) Appl. No.: 11/007,524

(22) Filed: Dec. 8, 2004

Related U.S. Application Data
(63) Continuation-in-part of application No. PCT/KR03/01241, filed on Jun. 25, 2003.

(30) Foreign Application Priority Data
Jun. 27, 2002 (KR) 10-2002-0036393

(51) Int. Cl. A61C 3/00; A61C 8/00

(52) U.S. Cl. 433/18; 433/173

(57) ABSTRACT

Disclosed is an orthodontic implant having a head part formed at an upper end thereof, a connection part for connection of an elastic member, a tool engagement part for engagement of a tool, a uniform diameter part, and a screw part having a predetermined length to be driven into an alveolar bone, which are sequentially formed in a downward direction. The screw part of the present invention has a sectional shape of an inverted cone which is widened at an upper end thereof and pointed at a lowered end thereof, and a pre-selected upper portion of a thread of the screw part, which portion corresponds to one or more leads of the thread, is formed to have a flattened crest of a predetermined width, and the remaining portion of the threads of the screw part are formed to have sharp-edged crest.

### CROSS REFERENCE TO RELATED APPLICATIONS

This application is a continuation-in-part application of a PCT international application, PCT/KR2003/001241, filed on Jun. 25, 2003, which claims priority to Korean Patent Application 10-2002-0036393, filed on Jun. 27, 2002, the PCT international application was published in English on Jan. 8, 2004.

### TECHNICAL FIELD

The present invention relates to an orthodontic implant to be implanted into an alveolar bone, and, more particularly, to an orthodontic implant of which a screw thread is shaped to be capable of being directly driven into an alveolar bone without requiring a separate drilling process, and to distribute more uniformly the force applied to the implant by a wire or a spring (hereinafter, referred to as an “elastic member”) connected from the brackets attached to teeth to a connection part of the implant to minimize the damage to the osseous tissue of the alveolar bone by the implant.

### BACKGROUND ART

In orthodontic treatment using an implant, it is very important to secure functional stabilities of the implant after implanted into alveolar bone. Such stabilities of the implant can be analyzed in two ways. One is the stability of the implant immediately after implanted into alveolar bone, and the other is the stability of the implant during the orthodontic treatment using the implant.

In order to ensure the stability of the implant immediately after implanted, it is necessary to minimize the damage to the osseous tissue of alveolar bone that would be caused by such implantation. For this purpose, it is preferable for an implant to be directly driven into the alveolar bone. In case that it is possible for an implant to be directly driven into alveolar bone, it is not necessary to have separate tapping and drilling processes in the alveolar bone, which would cause frictional heat detrimental to the osseous tissue of alveolar bone and further would take longer time for orthodontic treatment. In order for an implant to achieve this purpose, a screw thread of the implant should be shaped to have sharp edge.

In order to ensure the stability of the implant during the orthodontic treatment, it is necessary to distribute more uniformly the force applied to the implant by an elastic member connected from the brackets attached to teeth to a connection part of the implant and thereby to minimize the damage to the osseous tissue of the alveolar bone by the implant. In order for an implant to achieve this purpose, a certain part of the screw tread should be shaped to have relatively thick or stout edge.

In orthodontic treatment using an implant as seen from FIG. 1, brackets 26 are attached to teeth 11 to undergo orthodontics, and the screw part of the implant 20 is driven into an alveolar bone 10. Then, one end of an elastic member t is connected to the brackets 26 via intermediate means such as a wire, and the other end of the elastic member t is connected to a connection part of the implant 20, whereby a predetermined force required for orthodontic treatment is continuously applied to the teeth 11 to undergo orthodontics.

After implanted into alveolar bone, the implant 20 receives force from the elastic member t, and because the screw part of the implant 20 has a thread with a sharp-edged crest, the area of the alveolar bone where an implant is implanted receives substantial shearing stress by the screw thread of the implant 20. By such a shearing stress caused by the screw thread, the alveolar bone is likely to be gradually collapsed, and therefore, there would occur problems, such as inflammation in the area of the alveolar bone where the implant is implanted.

Referring to FIG. 2, there is illustrated a conventional implant as disclosed in Korean Utility Model Application No. 1999-30323. The implant designated by reference numeral 20 is formed at an upper end thereof with a head part 22. A connection part 23, a tool engagement part 24, an annular flange part 25, and a screw part 21 are sequentially formed below the head part 22. The annular flange part 25 is separated from the tool engagement part 24 to allow an elastic member to be connected to a shank portion of the implant 20, which extends between the tool engagement part 24 and the annular flange part 25. The screw part 21 has a predetermined length to be driven into an alveolar bone.

In the implant 20 constructed as described above, the screw part 21 driven into the alveolar bone has a shape of conventional screw spike, where the diameter of the screw is the same in the upper end and the lower end except for the terminal end, and therefore, the primary stability is reduced since it is not possible to minimize the damage to the cortical bone due to the vertical force added initially when the implant is implanted without drilling. Also, since the crest of a thread 27 has a sharp edge throughout the entire length of the screw part 21, the force applied to the implant 20 by the elastic member is concentrated to a certain portion of the alveolar bone by the sharp-edged crest of the thread, which brings subsequent collapse of the osseous tissue of the alveolar bone.

More concretely speaking, with reference to FIGS. 3a and 3b, to correct irregularities of teeth, the screw part 21 of the implant 20 is driven into the alveolar bone 10 (see FIG. 3a), and an end of the elastic member is connected to the shank portion extending between the tool engagement part 24 and the annular flange part 25, to apply predetermined orthodontic treatment force to the targeted teeth to undergo the orthodontics. By the presence of the sharp-edged thread of the screw part 21, however, excessive shearing stress is produced to adversely influence the alveolar bone, by which collapse of the alveolar bone is brought about, and therefore, the screw part 21 of the implant 20 is gradually inclined to the direction of the stress (see FIG. 3b). Consequently, the possibility of the implant 20 to be released from the alveolar bone is increased.

Besides the implant as described above, numerous kinds of orthodontic implants have been disclosed in the art. However, all these screw parts have the same diameter in their upper ends and the lower ends except for the terminal ends, or the threads of screw parts are formed to have sharp-edged crests throughout their entire lengths or shaped in such a way to require for a separate drilling process which produces heat detrimental to the osseous tissue. As a result, most of conventional implants has a drawback in that they adversely influence the alveolar bone during orthodontic treatment making their functional stability severely deteriorated.

### DISCLOSURE OF THE INVENTION

The present invention has been made keeping in mind the above problems occurring in the prior art, and an object of the present invention is to provide an implant in which a screw thread is shaped to be capable of being directly driven into an alveolar bone without performing a separate drilling process and to minimize the damage to the osseous tissue of the alveolar bone by the implant, thereby to improve the functional stability of the implant.

In order to achieve the above object, according to the present invention, there is provided an orthodontic implant having a head part formed at an upper end thereof, a connection part for connection of an elastic member, a tool engagement part for engagement of a tool, a uniform diameter part, and a screw part having a predetermined length to be driven into an alveolar bone, which are sequentially formed in a downward direction, wherein the screw part has a sectional shape of an inverted cone which is widened at an upper end thereof and pointed at a lowered end thereof, a pre-selected upper portion of a thread of the screw part, which portion corresponds to one or more leads of the thread, is formed to have a flattened crest of a predetermined width, and the remaining portion of the thread of the screw part is formed to have a sharp-edged crest.

In the present invention, the pre-selected upper portion of the thread of the screw part, which has the flattened crest of the predetermined width, has a length corresponding to a half of the predetermined length of the entire screw part, and formed in a manner such that the flattened crest has a largest width at an upper end thereof and is gradually decreased in its width toward a lower end thereof.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic view illustrating a state wherein orthodontics are treated using an implant;

FIG. 2 is a perspective view illustrating a conventional implant;

FIGS. 3a and 3b are views for explaining problems caused when a screw part of the conventional implant is driven into alveolar bone;

FIG. 4 is a perspective view illustrating an implant in accordance with an embodiment of the present invention;

FIG. 5 is a sectional view illustrating the implant according to the present invention; and

FIGS. 6a and 6b are views for explaining advantages rendered when a screw part of the implant according to the present invention is driven into gums.

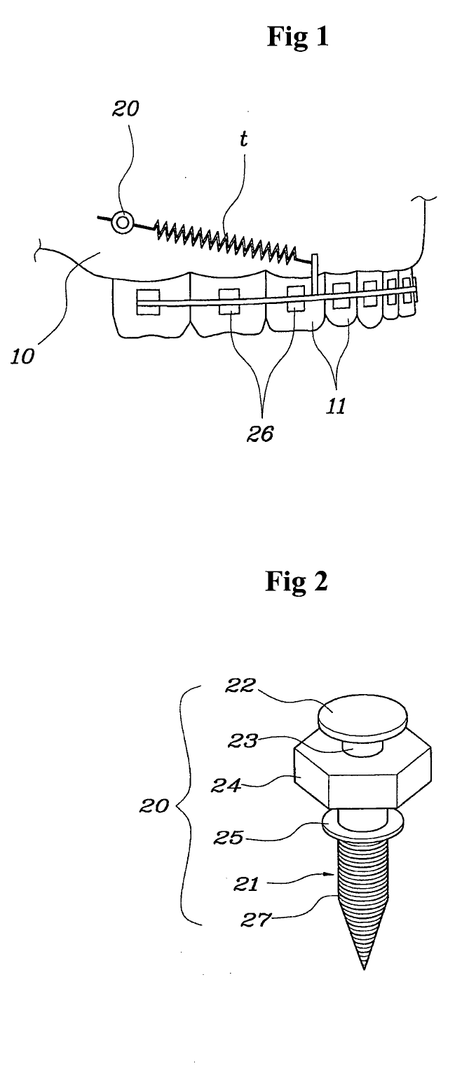

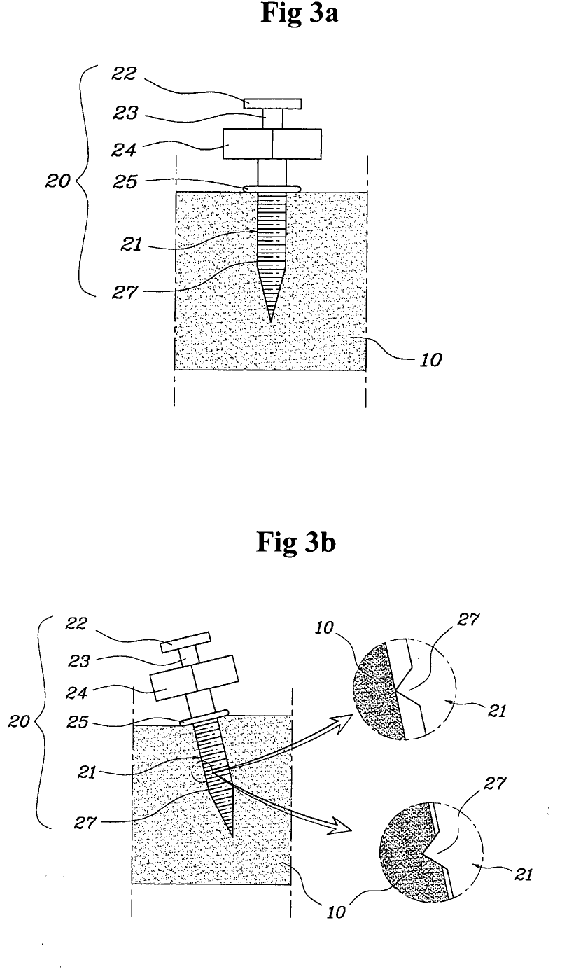

### BEST MODE FOR CARRYING OUT THE INVENTION

Reference should now be made to the drawings, in which the same reference numerals are used throughout the different drawings to designate the same or similar components.

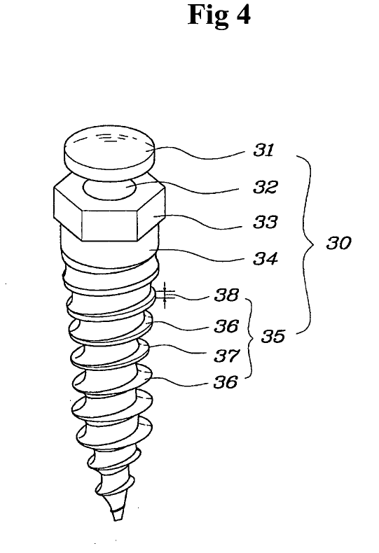

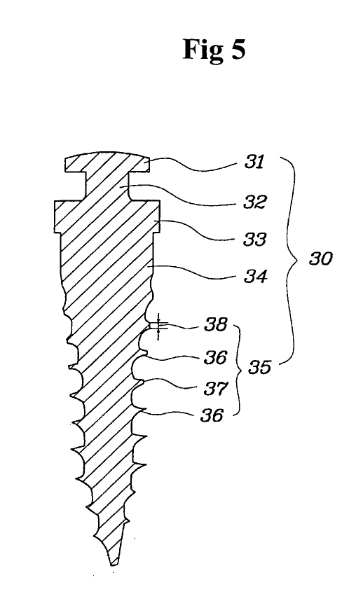

FIG. 4 is a perspective view illustrating an implant in accordance with an embodiment of the present invention; and FIG. 5 is a sectional view illustrating the implant according to the present invention. An implant 30 in accordance with an embodiment of the present invention has a head part 31 which is formed at an upper end thereof. A connection part 32 is formed at a lower end of the head part 31 to allow an elastic member t to be connected thereto. The head part 31 has a diameter larger than the connection part 32 to prevent the elastic member t from being unintentionally removed while the elastic member t is connected to the connection part 32.

The connection part 32, which is formed at the lower end of the head part 31 to allow the elastic member t to be connected thereto and which has a diameter smaller than the head part 31, has a preset length. By this fact, the elastic member t can be easily connected to the connection part 32.

A tool engagement part 33 is formed at a lower end of the connection part 32 in a manner such that a tool can be engaged around the tool engagement part 33 when driving the implant 30 into an alveolar bone 10. The tool engagement part 33 has a hexagonal nut-shaped configuration. The tool engagement part 33 has a diameter larger than the connection part 32 to, as in the case of the head part 31, prevent the elastic member t from being unintentionally removed while the elastic member t is connected to the connection part 32.

A uniform diameter part 34 is formed at a lower end of the tool engagement part 33 to have a pre-established length and a diameter smaller than the tool engagement part 33. A screw part 35 is formed at a lower end of the uniform diameter part 34 in a manner such that the screw part 35 can be driven into the alveolar bone 10 to be fixedly maintained therein. The screw part 35 has a predetermined length and a sectional shape of an inverted cone which is widened at an upper end thereof and pointed at a lowered end thereof.

The screw part 35 is formed to have the predetermined length which corresponds to several leads of a thread 36. A pre-selected upper portion of the thread 36 of the screw part 35, which portion corresponds to one or more leads of the thread 36, is formed in a manner such that a crest 37 of the thread 36 has a flattened surface 38 of a predetermined width, and the remaining portion of the thread 36 of the screw part 35 is formed in a manner such that the crest 37 of the thread 36 has a sharp-edged crest.

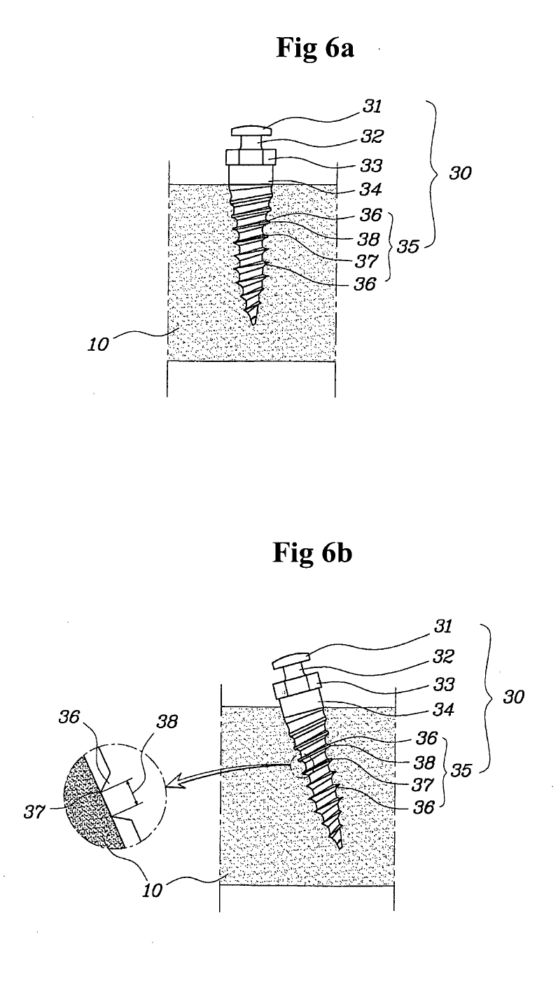

The reason why the flattened surface 38 of the predetermined width is formed on the crest 37 of the thread 36 is to overcome the problems occurring in the conventional screw part. That is to say, as shown in FIG. 6a, when a pulling force is applied to the implant 10 by the elastic member t after the screw part 35 is driven into the alveolar bone 10, since the flattened surface 38 of the crest 37 of the thread 36 is brought into surface contact with the alveolar bone 10 as shown in FIG. 6b, the force is applied to the alveolar bone 10 in a distributed manner rather than concentrated to a portion of the alveolar bone 10 to incise the alveolar bone 10, whereby damage to the alveolar bone 10 is minimized.

While it is preferred that the pre-selected upper portion of the thread 36 of the screw part 35, which has the flattened crest 37 of the predetermined width, has a length corresponding to a half of the predetermined length of the entire screw part 35, as occasion demands, it can be envisaged that the pre-selected upper portion of the thread 36 has a length corresponding to one or two leads of the thread 36 or exceeding the half of the predetermined length of the entire screw part 35. An orthodontic implant comprising a connection part for the connection of an elastic member and a tool engagement part for the engagement of a tool in the upper part, and a screw part to be driven into the alveolar bone in the lower part, wherein said screw part of which greater than a half of the length adjacent to the upper part has a shape of an inverted cone which is widened at the upper end and narrowed at the lower end, and a part of or the entire thread of said screw part is formed to have a sharp-edged crest and may be implanted directly.

It is preferred that the pre-selected upper portion of the thread 36 of the screw part 35 is formed in a manner such that the flattened crest 37 has a largest width at an upper end thereof and is gradually decreased in its width toward a lower end thereof. The reason for this is to allow the screw part 35 to be easily driven into the alveolar bone 10 and thereby obtain stable support force after installation of the implant 30.

### Industrial Applicability

As apparent from the above description, the implant according to the present invention provides advantages in that, since a drilling process, which otherwise produces frictional heat capable of damaging osseous tissue of an alveolar bone, is omitted, the functional stability of the implant is improved, and, since force applied to the implant by an elastic member can be more uniformly distributed over the alveolar bone, the functional stability of the implant is further improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An orthodontic implant comprising a connection part for the connection of an elastic member and a tool engagement part for the engagement of a tool in the upper part, and a screw part to be driven into the alveolar bone in the lower part, wherein said screw part of which greater than a half of the length adjacent to the upper part has a shape of an inverted cone which is widened at the upper end and narrowed at the lower end, and a part of or the entire thread of said screw part is formed to have a sharp-edged crest and may be implanted directly.

2. The orthodontic implant of claim 1, characterized by that a part of the thread of said screw part adjacent to the upper part has a predetermined flattened crest.

3. The orthodontic implant of claim 2, characterized by that the length of said screw part having the thread with a predetermined flattened crest formed is less than a half of the entire length of said screw part.

4. The orthodontic implant of claim 3, characterized by that the width of said flattened crest formed on the thread is formed in a manner that said width is the greatest at the thread located at the uppermost part and is gradually decreased toward the lower part.

5. The orthodontic implant of claim 4, characterized by that said connection part having a diameter which is greater than the diameter of said connection part is located below said connection part, and said connection part further comprises a head part having a diameter which is greater than the diameter of said connection part above said connection part.

6. The orthodontic implant of claim 1, characterized by that the upper part adjacent to said screw has an implant part having no thread formed.

7. The orthodontic implant of claim 2, characterized by that the upper part adjacent to said screw has an implant part having no thread formed.

8. The orthodontic implant of claim 3, characterized by that the upper part adjacent to said screw has an implant part having no thread formed.

9. The orthodontic implant of claim 4, characterized by that the upper part adjacent to said screw has an implant part having no thread formed.

10. The orthodontic implant of claim 5, characterized by that the upper part adjacent to said screw has an implant part having no thread formed.
